(19) United States
(12) Patent Application Publication
(10) Pub. No.: US 2012/0288297 A1
(43) Pub. Date: Nov. 15, 2012

(54) COLOR MISALIGNMENT CORRECTION IN IMAGE FORMING APPARATUS WHICH FORMS MULTICOLOR IMAGE

(75) Inventors: Mitsuhiro Sugeta, Abiko-shi (JP); Hirokazu Kodama, Ryugasaki-shi (JP)

(73) Assignee: CANON KABUSHIKI KAISHA, Tokyo (JP)

(21) Appl. No.: 13/458,991

(22) Filed: Apr. 27, 2012

(30) Foreign Application Priority Data
May 12, 2011 (JP) 2011-107634

(51) Int. Cl. G03G 15/01

(52) U.S. Cl. 399/72

(57) ABSTRACT

A pattern detection sensor receives light diffused by a pattern image, and it is difficult for the pattern detection sensor to detect a low-reflectance black pattern. Considering this, a high-reflectance yellow pattern is formed as the background of the low-reflectance black pattern. Even the diffused light reception type pattern detection sensor can detect the black pattern. The yellow pattern formed as the background is also used as a yellow pattern for detecting a color misalignment amount with respect to a pattern of magenta working as a reference color. The consumption amount of yellow toner is reduced while maintaining the color misalignment correction precision.

### BACKGROUND OF THE INVENTION

1. Field of the Invention

The present invention relates to an image forming apparatus which forms a multicolor image using printing agents of different colors.

2. Description of the Related Art

Multicolor image forming apparatuses which form a multicolor image by superimposing a plurality of basic colors (for example, yellow, magenta, cyan, and black) are becoming popular. The multicolor image forming apparatus forms a multicolor image by superimposing a plurality of colors. If the image forming positions of the respective colors shift from ideal positions, the image quality degrades. To reduce the image forming positional error, color misalignment correction patterns are formed by image forming units of the respective colors and read to compute the color misalignment amounts of the respective colors. The image forming positions are then corrected in accordance with the computed color misalignment amounts.

The correction pattern can be detected by an optical sensor or the like arranged near an intermediate transfer member. More specifically, the pattern is recognized by irradiating the intermediate transfer member with light emitted by a light emitting element, and detecting a difference between the quantity of light reflected by the surface of the intermediate transfer member and that of light reflected by the correction pattern formed on the intermediate transfer member. Japanese Patent Laid-Open No. 2007-156159 proposes a diffused light detection method as a method of detecting reflection light. More specifically, to detect a toner image of a low-reflectance color, the background is formed by a toner image of a high-reflectance color on an intermediate transfer member, and a toner image of the low-reflectance color is formed on the background.

The market demands higher color misalignment correction precisions year after year, and color misalignment correction tends to be executed more frequently. Conventional techniques form not only a pattern for performing color misalignment correction, but also a background pattern, so the consumption amount of a printing agent such as toner increases. In conventional techniques, consumption of toner raises the running cost. Moreover, capacity of a toner recovery vessel needs to be upsized. It raises the manufacturing cost.

### SUMMARY OF THE INVENTION

According to the present invention an image forming apparatus is provided with the following elements. A forming unit is configured to form, on an objective member, a reference color pattern of a reference color, a first pattern of a first color different from the reference color, and a second pattern of a second color which is different from the reference color and the first color and lower in reflectance than the first color, the second pattern being smaller in area than the first pattern and being superimposed on the first pattern. A light emitting unit is configured to irradiate, with light, the reference color pattern, first pattern, and second pattern formed on the objective member. A light receiving unit is configured to receive diffused light components from the reference color pattern, the first pattern, and the second pattern, and output signals. A specifying unit is configured to specify a misalignment amount of an image forming position of the first color with respect to an image forming position of the reference color from the output signal of the reference color pattern and the output signal of the first pattern, and specify a misalignment amount of an image forming position of the second color with respect to the image forming position of the reference color from the output signal of the reference color pattern and the output signal of the second pattern. An adjustment unit is configured to adjust the image forming position of the first color and the image forming position of the second color based on the misalignment amounts specified by the specifying unit.

Further features of the present invention will become apparent from the following description of exemplary embodiments (with reference to the attached drawings).

### BRIEF DESCRIPTION OF THE DRAWINGS

FIG. 1 is a schematic view for explaining the arrangement of the image forming unit of an image forming apparatus;

FIG. 2 is a view showing the optical relationship between the light emitting element and diffused light receiving element of a pattern detection sensor;

FIG. 3 is a block diagram showing a control system;

FIG. 4 is a view showing a color misalignment correction pattern image;

FIG. 5A is a view showing a pattern image, analog detection signal, and digital detection signal according to an embodiment;

FIG. 5B is a view showing a pattern image, analog detection signal, and digital detection signal in a comparative example;

FIG. 6 is a view showing a method of measuring the color misalignment amount of a yellow pattern formed as the background of a black pattern with respect to magenta;

FIG. 7 is a view showing the relationship between the color misalignment amount and the write start timing; and

FIG. 8 is a flowchart showing print processing including color misalignment correction processing.

### DESCRIPTION OF THE EMBODIMENTS

A preferred embodiment of the present invention will now be described in detail by way of example with reference to the accompanying drawings. The sizes, materials, shapes, and relative arrangements of constituent components described in the following embodiment are not intended to limit the scope of the invention, unless otherwise specified.

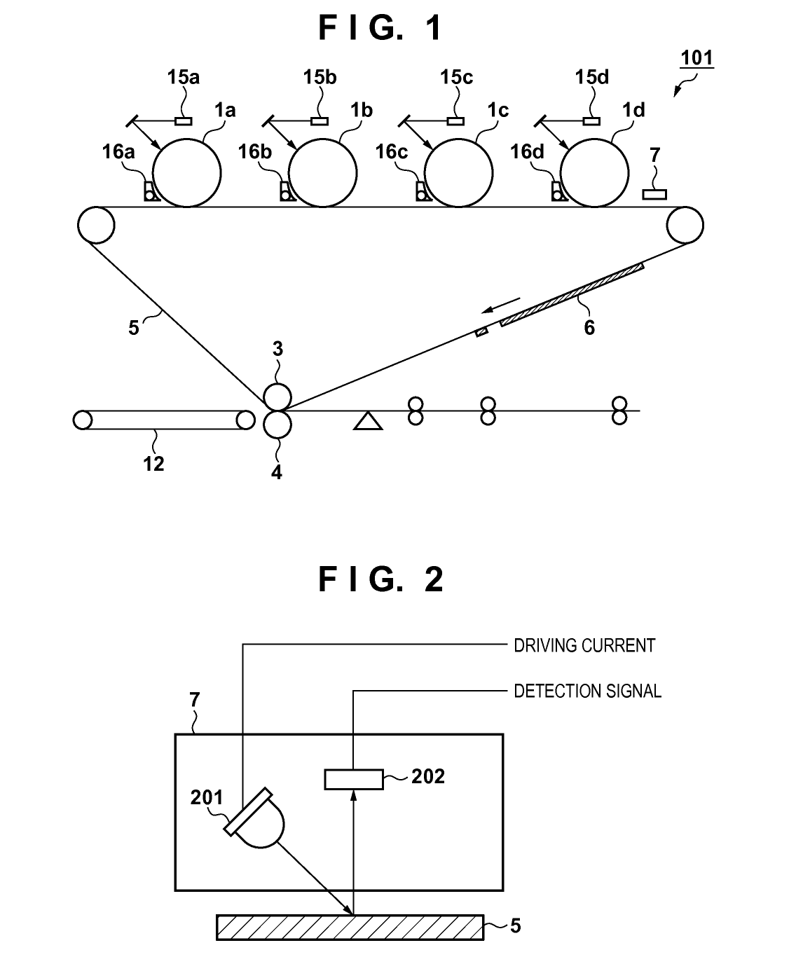

Referring to FIG. 1, exposure devices 15a, 15b, 15c, and 15d are arranged in the order of yellow (Y), cyan (C), magenta (M), and black (K) in an image forming unit 101 of a multicolor image forming apparatus. The exposure devices 15a, 15b, 15c, and 15d expose uniformly charged photosensitive drums 1a, 1b, 1c, and 1d, forming latent images. Developing units 16a, 16b, 16c, and 16d develop the respective latent images, forming toner images. The toner images formed on the photosensitive drums 1a, 1b, 1c, and 1d are sequentially transferred onto the surface of an intermediate transfer belt 5 to overlap each other. As a result, a multicolor toner image 6 is formed. The toner image 6 is transferred onto paper at a contact portion (transfer position) between a belt support roller 3 and a transfer roller 4. A conveyance belt 12 conveys the paper to a fixing unit (not shown). The fixing unit fixes the toner image onto the paper.

As shown in FIG. 1, a pattern detection sensor 7 is arranged near the surface of the intermediate transfer belt 5. The pattern detection sensor 7 reads the color misalignment correction pattern of each color formed on the surface of the intermediate transfer belt 5 or the surface itself (that is, background) of the intermediate transfer belt 5. The reading result represents the misalignment amount of the image forming position of each color from an ideal position. The image forming position is adjusted in accordance with the misalignment amount, relaxing the color misalignment. As is well known, the image forming positions are adjusted by adjusting the write start timings of the exposure devices 15a, 15b, 15c, and 15d.

The arrangement of the pattern detection sensor 7 will be exemplified with reference to FIG. 2. The pattern detection sensor 7 functions as a detection unit configured to detect a pattern image of each color formed by the image forming unit 101. A light emitting element 201 functions as a light emitting unit configured to irradiate, with light, a reference color pattern, first pattern, and second pattern formed on an objective member. A light receiving element 202 functions as a light receiving unit configured to receive diffused light components from the reference color pattern, first pattern, and second pattern and output signals. Also, the light receiving element 202 is an example of a light receiving element configured to receive a diffused light component and output an analog signal of a level corresponding to the light receiving amount. Light emitted by the light emitting element 201 irradiates the intermediate transfer belt 5 or a toner pattern formed on it. The light receiving element 202 is arranged at a position where it can receive light diffused by a toner pattern. A photocurrent corresponding to the quantity of received light flows through the light receiving element 202. This current is converted into a voltage by a resistor, and output as an analog detection signal AS.

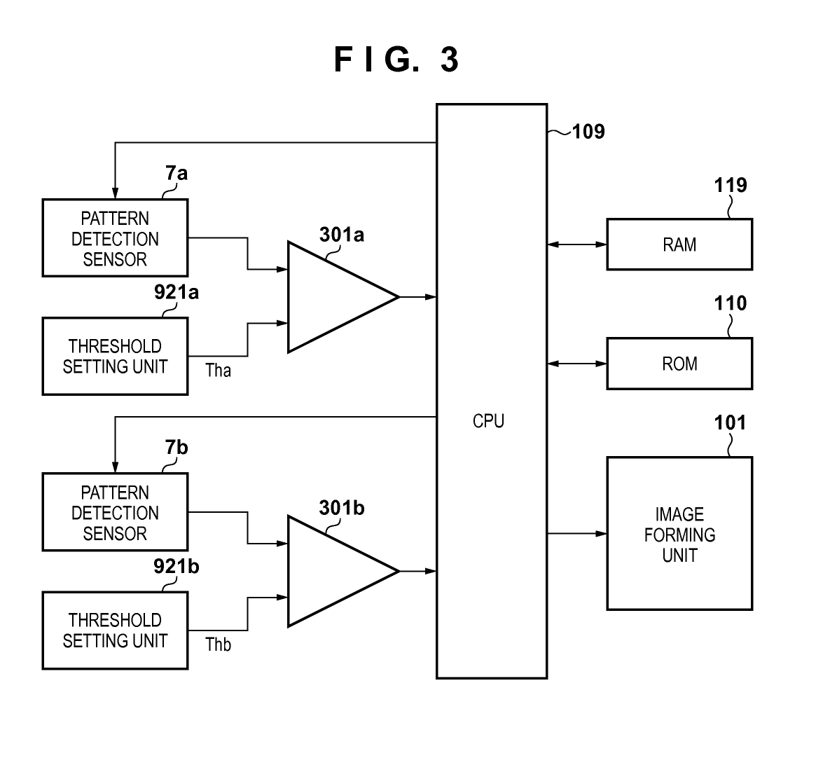

FIG. 3 is a block diagram showing a control system. A CPU 109 is the center of the control system, and controls various processing. The CPU 109 runs based on programs stored in a ROM 110. A RAM 119 is used as the work area of the CPU 109. The CPU 109 outputs a control signal to control the image forming unit 101, and causes the image forming unit 101 to form an image. When performing color misalignment correction, the CPU 109 generates source image data of a color misalignment correction pattern image, and outputs it to the image forming unit 101. The exposure devices 15a, 15b, 15c, and 15d in the image forming unit 101 output laser beams from laser diodes in accordance with image data, forming electrostatic latent images on the photosensitive drums 1a, 1b, 1c, and 1d. The image forming unit 101 functions as a forming unit configured to form a plurality of patterns of different colors on an objective member under the control of the CPU 109. In the embodiment, a reference color pattern of a reference color, the first pattern of the first color different from the reference color, and the second pattern of the second color different from the reference color and first color are formed as a plurality of patterns. In particular, the second pattern is a pattern of the second color lower in reflectance than the first color, is smaller in area than the first pattern, and is superimposed on the first pattern.

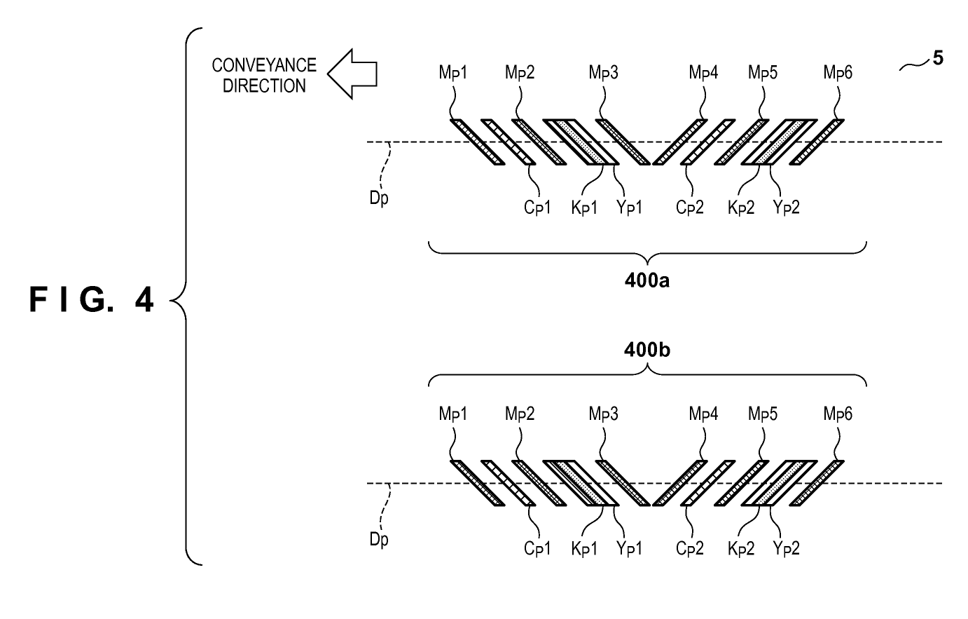

As shown in FIG. 4, color misalignment correction pattern images are formed near two ends on the outer surface of the intermediate transfer belt 5 working as an endless belt. This is because a toner image to be transferred onto printing paper is formed at the center of the outer surface of the intermediate transfer belt 5, and the toner image to be transferred is not formed near the ends. The pattern detection sensor 7 prepares two systems to detect color misalignment correction pattern images 400a and 400b respectively formed at the two ends. The suffixes “a” and “b” are used to discriminate these two systems. When matters common to these two systems are explained, these suffixes will be omitted.

Referring to FIG. 4, the color misalignment correction pattern images 400a and 400b have the same pattern. Each pattern image includes magenta patterns Mp1, Mp2, Mp3, Mp4, Mp5, and Mp6, cyan patterns Cp1 and Cp2, yellow patterns Yp1 and Yp2, and black patterns Kp1 and Kp2. In this case, the magenta pattern is a reference color pattern for measuring a color misalignment amount. The yellow patterns Yp1 and Yp2 are the high-reflectance first pattern of a color different from the reference color. The black pattern is the low-reflectance second pattern which is a pattern of a color different from the reference color and the color of the first pattern and is smaller in area than the first pattern. The black pattern working as the second pattern is superimposed on the yellow pattern working as the first pattern. In the embodiment, the yellow patterns Yp1 and Yp2 are formed in order to detect the black patterns Kp1 and Kp2 using diffused light. Moreover, the yellow patterns Yp1 and Yp2 are also used as patterns for measuring a color misalignment amount. Note that M, Y, C, and K stand for magenta, yellow, cyan, and black, respectively. In FIG. 4, Dp is the detection position of the pattern detection sensor 7.

Referring to FIG. 3, the pattern detection sensors 7a and 7b are diffused reflection optical sensors which receive light diffused by the intermediate transfer belt 5 and a color misalignment correction pattern image formed on it. The pattern detection sensor 7a is arranged at a position where it can detect the color misalignment correction pattern image 400a formed near one end. The pattern detection sensor 7b is arranged at a position where it can detect the color misalignment correction pattern image 400b formed near the other end. The pattern detection sensor 7a detects the color misalignment correction pattern image 400a, and outputs a detection signal to a comparator 301a. The comparator 301a compares a threshold Tha set by a threshold setting unit 921a with the detection signal level, and outputs a digital signal working as the comparison result. Similarly, the pattern detection sensor 7b detects the color misalignment correction pattern image 400b, and outputs a detection signal to a comparator 301b. The comparator 301b compares a threshold Thb set by a threshold setting unit 921b with the detection signal level, and outputs a digital signal working as the comparison result. The comparator 301 functions as an analog-to-digital converter configured to compare the level of an analog signal output from the light receiving element with a threshold, and output a digital signal. The CPU 109 computes a color misalignment amount based on the digital signal, and adjusts the write start timing of each exposure device in accordance with the color misalignment amount. That is, the CPU 109 functions as an adjustment unit configured to adjust the image forming positions of the first and second colors based on specified misalignment amounts.

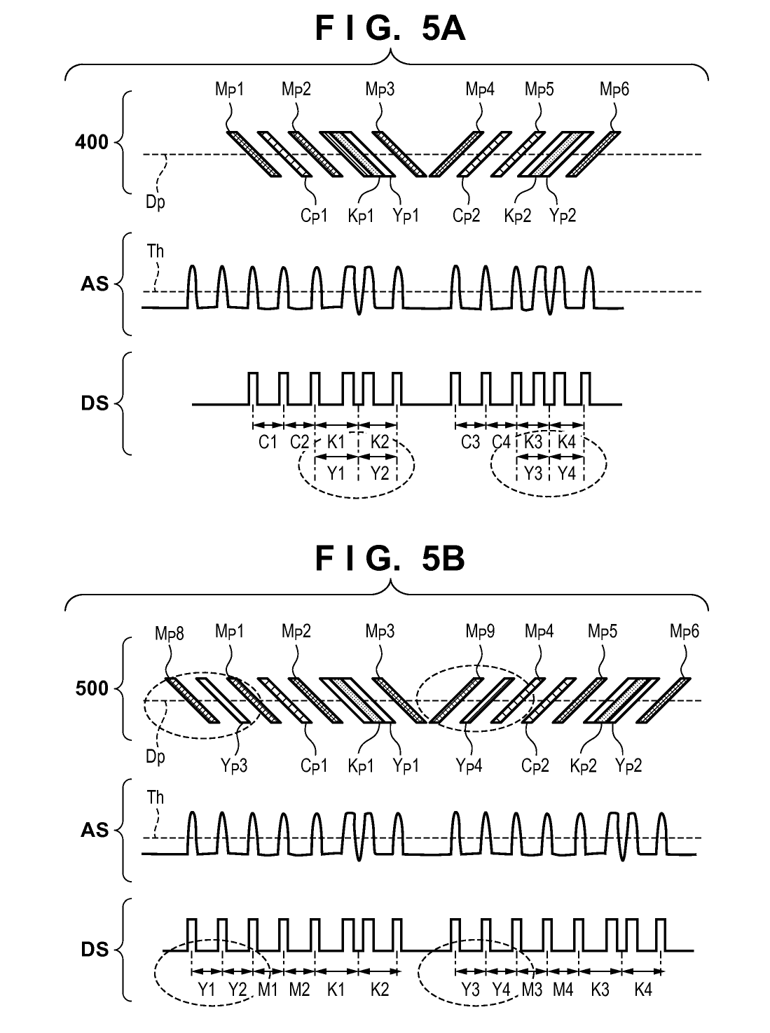

FIG. 5A shows the color misalignment correction pattern image 400, the analog detection signal AS output from the pattern detection sensor 7 which has detected the pattern image, and a corresponding digital detection signal DS of this embodiment. The color misalignment correction pattern image 400 has strip-shaped patterns inclined by 45 degrees in the conveyance direction (moving direction of the intermediate transfer belt 5) to detect a misalignment amount from the reference color in the main scanning direction and a misalignment amount from the reference color in the sub-scanning direction. Since magenta is set as a reference color, each of the yellow pattern Yp, cyan pattern Cp, and black pattern Kp is sandwiched between the two magenta patterns Mp. As shown in FIG. 5A, the comparator 301 compares the analog detection signal AS with the threshold Th, and outputs the digital detection signal DS working as the comparison result to the CPU 109. The CPU 109 computes the center position of the pulse of the digital detection signal DS corresponding to the pattern of each color, and computes a distance (time interval) between a center position for the reference color and a center position for another color. For example, the time interval between the cyan pattern Cp1 and the magenta pattern Mp1 is C1, and that between the cyan pattern Cp1 and the magenta pattern Mp2 is C2. The CPU 109 functions as a specifying unit configured to specify the misalignment amount of the image forming position of the first color with respect to the image forming position of the reference color from the output signal of the reference color and that of the first pattern, and specify the misalignment amount of the image forming position of the second color with respect to the image forming position of the reference color from the output signal of the reference color and that of the second pattern.

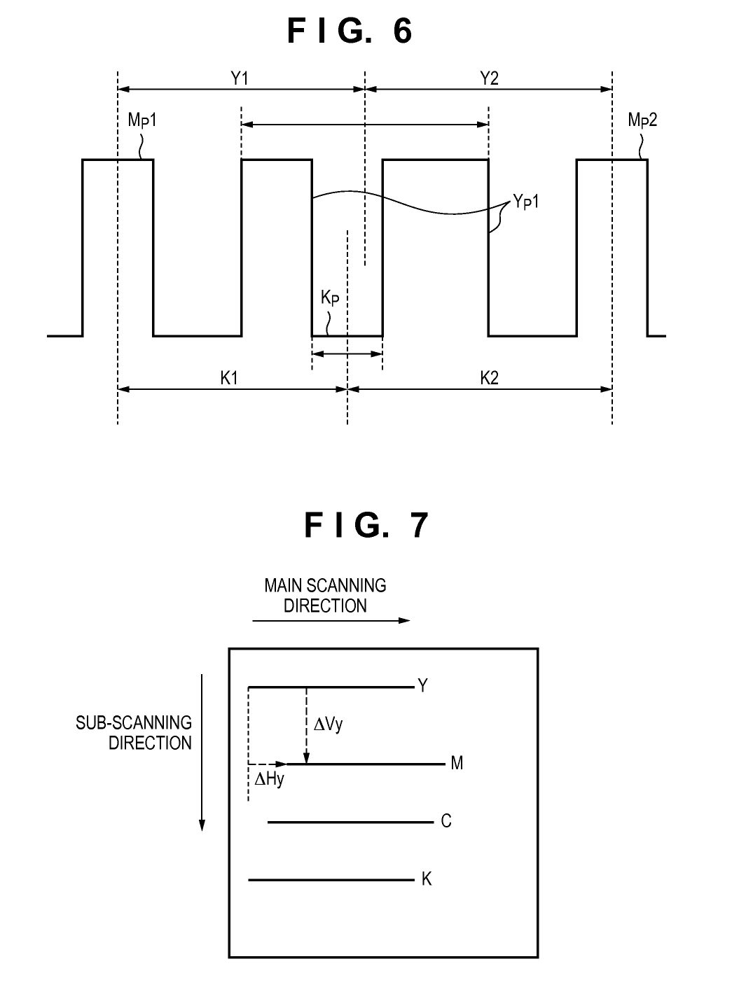

FIG. 6 is a view showing a method of obtaining the center positions and time intervals of the black and yellow patterns. As shown in FIGS. 4 and 5A, the yellow pattern Yp is formed as the background of the black pattern Kp. It is difficult for the diffused light reception type pattern detection sensor 7 to detect a low-reflectance toner such as black toner. For this reason, a high-reflectance toner such as yellow toner is used as the background to form a black pattern. The CPU 109 detects the black pattern on the assumption that the black pattern exists in a section where no yellow pattern can be detected.

As shown in FIG. 6, the CPU 109 computes, as the center position, the median point of a section from the leading edge to trailing edge of a pulse for the magenta patterns Mp1 and Mp2. The pulse of the yellow pattern Yp1 is divided into former and latter pulses by the black pattern Kp1. Thus, the CPU 109 computes, as the center position, the median point of a section from the leading edge of the former pulse to the trailing edge of the latter pulse for the yellow pattern Yp1. The CPU 109 computes, as the center position of the pulse of the black pattern Kp1, the median point of a section from the tailing edge of the former pulse to the leading edge of the latter pulse for the yellow pattern Yp1. After the center positions are obtained in this way, the distance between them can be obtained as a time interval. For example, a time interval Y1 is computed as the distance between the center position of the magenta pattern Mp1 and that of the yellow pattern Yp1. A time interval K1 is computed as the distance between the center position of the magenta pattern Mp1 and that of the black pattern Kp1. The CPU 109 functions as a unit configured to execute the following processing. The CPU 109 obtains the median point of a section from the leading edge to trailing edge of the pulse of a digital signal for the reference color pattern. For the first pattern, the CPU 109 obtains the median point of a section from the leading edge of a former pattern to the trailing edge of a latter pattern out of two patterns formed by dividing the first pattern into two by the second pattern. For the second pattern, the CPU 109 obtains the median point of a section from the trailing edge of the former pattern to the leading edge of the latter pattern. The CPU 109 computes the distance from the median point of the reference color pattern to that of the first pattern as the misalignment amount of the image forming position of the color of the first pattern. The CPU 109 computes the distance from the median point of the reference color pattern to that of the second pattern as the misalignment amount of the image forming position of the color of the second pattern.

After computing time intervals C1, C2, Y1, Y2, K1, K2, C3, C4, Y3, Y4, K3, and K4, the CPU 109 stores them in the RAM 119. The CPU 109 computes the color misalignment amounts of the remaining colors with respect to magenta based on the stored time interval data. For example, the main scanning misalignment amount ΔHy of yellow with respect to magenta can be computed in accordance with the following equation:

ΔHy={(Y4−Y3)/2−(Y2−Y1)/2}/2

Similarly, the sub-scanning misalignment amount ΔVy of yellow with respect to magenta can be computed in accordance with the following equation:

ΔVy={(Y4−Y3)/2+(Y2−Y1)/2}/2

The main scanning misalignment amount ΔHc of cyan with respect to magenta can be computed in accordance with the following equation:

ΔHc={(C4−C3)/2−(C2−C1)/2}/2

Similarly, the sub-scanning misalignment amount ΔVc of cyan with respect to magenta can be computed in accordance with the following equation:

ΔVc={(C4−C3)/2+(C2−C1)/2}/2

The main scanning misalignment amount ΔHk of black with respect to magenta can be computed in accordance with the following equation:

ΔHk={(K4−K3)/2−(K2−K1)/2}/2

Similarly, the sub-scanning misalignment amount ΔVk of black with respect to magenta can be computed in accordance with the following equation:

ΔVk={(K4−K3)/2+(K2−K1)/2}/2

The CPU 109 corrects a color misalignment by controlling the image forming unit 101 to control the write start timing of yellow based on ΔHy and ΔVy. More specifically, the CPU 109 decreases color misalignment by adjusting the exposure timing of the exposure device 15 of the image forming unit 101 to control the write start timing.

FIG. 7 is a view for explaining the color misalignment amount and the write start timing. Each of Y, M, C, and K represents one line of each color in the main scanning direction when color misalignment occurs. Here, attention is paid to yellow. The color misalignment amounts ΔHy and ΔVy of yellow with respect to magenta that are computed by the CPU 109 appear in an image, as shown in FIG. 7. For a computed color misalignment amount in the main scanning direction, the CPU 109 controls the laser beam exposure timing of the exposure device 15 for each image clock or each sub-clock obtained by dividing the image clock into 1/16. Accordingly, the image forming position of yellow in the main scanning direction can be aligned with that of magenta. For a computed color misalignment amount in the sub-scanning direction, the CPU 109 controls the laser beam exposure timing of the exposure device 15 for each BD (Beam Detection) period or each sub-clock obtained by dividing the BD period into 1/16. Note that the beam detection period is the output period of the BD signal output every time a laser beam scans once in the main scanning direction. The color misalignment amounts of black and cyan can also be reduced by the same method. In this manner, the CPU 109 corrects the exposure start timing by the misalignment amount.

FIG. 5B shows a color misalignment correction pattern image 500, the analog detection signal AS output from the pattern detection sensor 7 which has detected the pattern image, and a corresponding digital detection signal DS in a comparative example. The comparative example requires magenta patterns Mp8 and Mpg, and yellow patterns Yp3 and Yp4 in order to measure the color misalignment of yellow with respect to magenta. In the present invention, the yellow pattern formed as the background pattern of the black pattern is used not only as the background but also for measurement of the color misalignment amount. That is, the pattern image 400 shown in FIG. 5A according to the embodiment can save the consumption amount of yellow and that of magenta working as the reference color, compared to the pattern image 500 in the comparative example.

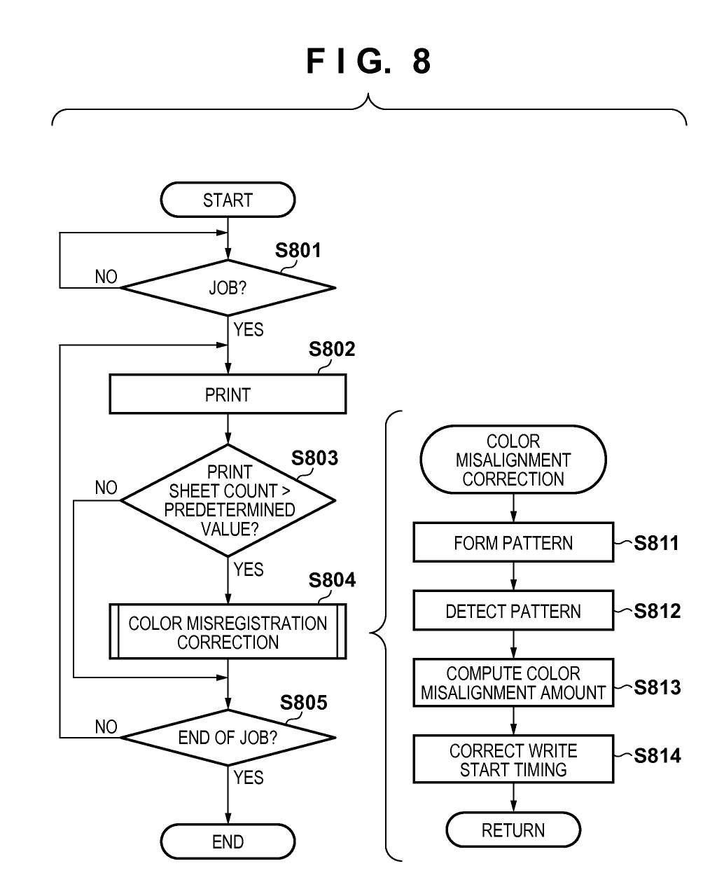

FIG. 8 is a flowchart showing color misalignment correction processing according to the embodiment. In step S801, the CPU 109 determines whether it has received a print job from a host computer or the operation unit. If the CPU 109 has received a print job, it advances to step S802 in order to shift from the standby state to the print state.

In step S802, the CPU 109 executes print processing in accordance with the print job. In printing, the CPU 109 controls the image forming unit 101 to form an image using a write start timing corrected by color misalignment correction processing. Hence, the image forming positions of the remaining colors coincide with that of the reference color. That is, color misalignment of the respective colors is relaxed. The CPU 109 counts (accumulates) printing sheets every time an image is printed on a printing sheet.

In step S803, the CPU 109 determines whether the print sheet count by the counter has exceeded a predetermined value. The predetermined value is a print sheet count at which color misalignment correction is required. The predetermined value is determined by an experiment or simulation. In this case, the color misalignment correction start condition is the print sheet count, but may be a condition that the running period of the image forming apparatus has exceeded a predetermined period, a condition that an environmental parameter such as temperature or humidity has changed by a predetermined value or more, or a condition that a part has been replaced. This is because it suffices to execute color misalignment correction processing at the timing when the color misalignment amount exceeds an allowable range. If the print sheet count has not exceeded the predetermined value, the process skips color misalignment correction processing in step S804 and advances to step S805. If the print sheet count has exceeded the predetermined value, the process advances to step S804.

In step S805, the CPU 109 determines whether all received print jobs have ended. If print jobs have not been completed, the process returns to step S802, and the CPU 109 executes the remaining print jobs. If all received print jobs have ended, the CPU 109 ends print processing and returns to the standby state.

Color misalignment correction processing in step S804 is divided into sub-steps S811 to S814 and will be explained in detail.

In step S811, the CPU 109 controls the image forming unit 101 to form the color misalignment correction pattern image 400 on the intermediate transfer belt 5. The image forming unit 101 forms, as the background, a pattern of the high-reflectance first color different from the reference color, and forms a pattern of the low-reflectance second color on the pattern of the first color.

In step S812, the CPU 109 detects the pattern image 400 using the pattern detection sensor 7. The pattern detection sensor 7 functions as a detection unit configured to detect, from diffused light, patterns of the respective colors formed by respective image forming units.

In step S813, the CPU 109 computes, from the pattern image, the color misalignment amount of another color with respect to the reference color.

More specifically, the CPU 109 specifies, as the color misalignment amount of another color, the distance between the center position of a reference color pattern formed in the reference color and that of a pattern of the other color different from the reference color out of the patterns of the respective colors detected by the pattern detection sensor 7. When magenta is the reference color, the CPU 109 computes color misalignment amounts in the main scanning direction and color misalignment amounts in the sub-scanning direction for yellow, cyan, and black. As described above, in the embodiment, a yellow pattern formed as the background of a black pattern is also used as a yellow pattern for measuring a color misalignment amount with respect to magenta. In this way, the CPU 109 specifies the color misalignment amount of the first color from a reference color pattern and the first color pattern formed as the background of the second color pattern. Also, the CPU 109 specifies the color misalignment amount of the second color from the reference color pattern and the second color pattern.

In step S814, the CPU 109 corrects write start timings in the main scanning direction using color misalignment amounts in the main scanning direction for the respective colors other than the reference color, and corrects write start timings in the sub-scanning direction using color misalignment amounts in the sub-scanning direction. In this way, the CPU 109 corrects the write start timings of the remaining colors in accordance with color misalignment amounts specified by the specifying unit so that the image forming positions of the remaining colors come close to that of the reference color.

According to the embodiment, a pattern of a high-reflectance (brightness) color that is formed as the background of a pattern of a low-reflectance color is also used as a pattern for measuring a color misalignment amount with respect to the reference color. While maintaining the color misalignment correction precision, the embodiment can reduce consumption of a printing agent, compared to the conventional technique. Note that a pattern image formed on the intermediate transfer belt 5 is retrieved to a retrieval vessel without transferring it onto printing paper. If the consumption amount of toner for forming a color misalignment correction pattern image decreases, the retrieval vessel can be relatively downsized. The embodiment is also advantageous in space efficiency and manufacturing cost.

The embodiment has described the intermediate transfer belt 5 as an example of an objective member on which a pattern image is formed. However, a pattern may be formed on continuous paper or on a sheet conveyed by the paper conveyance belt. In this case, the arrangement of the pattern detection sensor 7 is changed to a position where the pattern detection sensor 7 can detect continuous paper or a sheet. However, the use of the intermediate transfer belt 5 would be superior to the use of continuous paper or a sheet in terms of the running cost. However, when continuous paper or a sheet is used, a pattern is free from the influence of the gloss of the surface of the intermediate transfer belt 5.

The embodiment has exemplified an image forming apparatus which prints using an electrophotographic process. However, the present invention is not limited to this and is also applicable to, for example, an inkjet printing apparatus. This is because the technical concept of the present invention is applicable to any image forming method which uses printing agents (for example, toners or inks) of a plurality of colors.

In the embodiment, the color misalignment amount is specified by computing the center position of the pulse of a detection signal. However, the color misalignment amount may be specified using a position where an analog signal waveform peaks, or the center of gravity of the pulse. In this case, the peak position or the position of the center of gravity is used instead of the above-mentioned center position. The CPU 109 obtains the peak position of the level of an analog signal corresponding to the reference color pattern. The CPU 109 obtains the peak position of the level of an analog signal corresponding to the first pattern. The CPU 109 obtains the peak position of the level of an analog signal corresponding to the second pattern. The CPU 109 computes the distance from the peak position of the reference color pattern to that of the first pattern as the misalignment amount of the image forming position of the color of the first pattern. The CPU 109 computes the distance from the peak position of the reference color pattern to that of the second pattern as the misalignment amount of the image forming position of the color of the second pattern. Similarly, the CPU 109 obtains the center of gravity of the pulse of a digital signal corresponding to the reference color pattern. The CPU 109 obtains the center of gravity of the pulse of a digital signal corresponding to the first pattern. The CPU 109 obtains the center of gravity of the pulse of a digital signal corresponding to the second pattern. The CPU 109 computes the distance from the center of gravity of the reference color pattern to that of the first pattern as the misalignment amount of the image forming position of the color of the first pattern. The CPU 109 computes the distance from the center of gravity of the reference color pattern to that of the second pattern as the misalignment amount of the image forming position of the color of the second pattern.

The embodiment has employed yellow as a high-reflectance color, but may adopt magenta or cyan because magenta and cyan are also higher in reflectance than black. In this case, the reference color is a color different from one employed as the background. For example, when the background is magenta, the reference color is yellow or cyan. An example of the first pattern is a pattern of a color different from the reference color out of magenta, cyan, and yellow, and an example of the second pattern is a black pattern.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-107634, filed May 12, 2011 which is hereby incorporated by reference herein in its entirety.

What is claimed is:

1. An image forming apparatus comprising:
a forming unit configured to form, on an objective member, a reference color pattern of a reference color, a first pattern of a first color different from the reference color, and a second pattern of a second color which is different from the reference color and the first color and lower in reflectance than the first color, the second pattern being smaller in area than the first pattern and being superimposed on the first pattern;
a light emitting unit configured to irradiate, with light, the reference color pattern, first pattern, and second pattern formed on the objective member;
a light receiving unit configured to receive diffused light components from the reference color pattern, the first pattern, and the second pattern, and output signals;
a specifying unit configured to specify a misalignment amount of an image forming position of the first color with respect to an image forming position of the reference color from the output signal of the reference color pattern and the output signal of the first pattern, and specify a misalignment amount of an image forming position of the second color with respect to the image forming position of the reference color from the output signal of the reference color pattern and the output signal of the second pattern; and
an adjustment unit configured to adjust the image forming position of the first color and the image forming position of the second color based on the misalignment amounts specified by said specifying unit.

2. The apparatus according to claim 1, wherein
said light receiving unit includes
a light receiving element configured to receive the diffused light component, and
an analog-to-digital converter configured to compare a level of an analog signal output from said light receiving element with a threshold and output a digital signal, and
said specifying unit obtains, for the reference color pattern, a median point of a section from a leading edge to trailing edge of a pulse of the digital signal corresponding to the reference color pattern,
for the first pattern, obtains a median point of a section from a leading edge of a pulse of the digital signal corresponding to a former pattern to a trailing edge of a pulse of the digital signal corresponding to a latter pattern out of two patterns formed by dividing the first pattern into two by the second pattern,
for the second pattern, obtains a median point of a section from a trailing edge of the pulse of the digital signal corresponding to the former pattern to a leading edge of the pulse of the digital signal corresponding to the latter pattern,
computes a distance from the median point of the reference color pattern to the median point of the first pattern as a misalignment amount of the image forming position of the first color, and
computes a distance from the median point of the reference color pattern to the median point of the second pattern as a misalignment amount of the image forming position of the second color.

3. The apparatus according to claim 1, wherein
said light receiving unit includes
a light receiving element configured to receive the diffused light component, and
an analog-to-digital converter configured to compare a level of an analog signal output from said light receiving element with a threshold and output a digital signal, and
said specifying unit obtains a center of gravity of a pulse of the digital signal corresponding to the reference color pattern,
obtains a center of gravity of a pulse of the digital signal corresponding to the first pattern,
obtains a center of gravity of a pulse of the digital signal corresponding to the second pattern,
computes a distance from the center of gravity of the reference color pattern to the center of gravity of the first pattern as a misalignment amount of the image forming position of the first color, and
computes a distance from the center of gravity of the reference color pattern to the center of gravity of the second pattern as a misalignment amount of the image forming position of the second color.

4. The apparatus according to claim 1, wherein
said light receiving unit includes
a light receiving element configured to receive the diffused light component and output an analog signal of a level corresponding to a light receiving amount, and
said specifying unit obtains a peak position of a level of the analog signal corresponding to the reference color pattern,
obtains a peak position of a level of the analog signal corresponding to the first pattern,
obtains a peak position of a level of the analog signal corresponding to the second pattern,
computes a distance from the peak position of the reference color pattern to the peak position of the first pattern as a misalignment amount of the image forming position of the first color, and
computes a distance from the peak position of the reference color pattern to the peak position of the second pattern as a misalignment amount of the image forming position of the second color.

5. The apparatus according to claim 1, wherein said forming unit forms the reference color pattern, first pattern, and second pattern which are inclined by 45 degrees in a moving direction of the objective member and have a strip shape.

6. The apparatus according to claim 1, wherein the first pattern is a pattern of a color different from the reference color out of magenta, cyan, and yellow, and the second pattern is a black pattern.
